(19) United States
(12) Patent Application Publication
(10) Pub. No.: US 2023/0306801 A1
(43) Pub. Date: Sep. 28, 2023

(54) APPARATUS AND METHODS FOR DETERMINING CHARGING EFFICIENCY RATES FOR SOLAR-POWERED VEHICLES

(71) Applicant: HERE GLOBAL B.V., EINDHOVEN (NL)

(72) Inventors: Jerome BEAUREPAIRE, Nantes (FR); Marko Tuukkanen, Schienzer (DE)

(73) Assignee: HERE GLOBAL B.V., EINDHOVEN (NL)

(21) Appl. No.: 17/704,377

(22) Filed: Mar. 25, 2022

(51) Int. Cl. G07C 5/08; B60L 8/00; G01C 21/00

(52) U.S. Cl. CPC G07C 5/0816; B60L 8/003; G01C 21/3811; G01C 21/3826

(57) ABSTRACT

An apparatus, method and computer program product are provided for predicting charging efficiency rates for solar-powered vehicles. In one example, the apparatus receives historical data of events in which solar-powered vehicles equipped with solar panels were electrically charged by receiving solar beams at the solar panels. The historical data indicate factors of the events that induced objects forming on the solar panels and obstructing, at least in part, the solar beams. The apparatus uses the historical data to train a machine learning model to output a charging efficiency rate of a target solar-powered vehicle as a function of at least one attribute associated with a location.

### TECHNICAL FIELD

The present disclosure generally relates to the field of solar-powered vehicles, associated methods and apparatus, and in particular, concerns, for example, an apparatus configured to determine charging efficiency rates for solar-powered vehicles based on attributes associated with one or more locations.

### BACKGROUND

Certain modern electric vehicles are integrated with solar panels to receive solar beams and charge power sources of the vehicles. Solar-powered vehicles may be charged without establishing electric connection between the vehicles and charging sources and/or supplement charging with solar energy in addition to generic charging methods. It is known that the effectiveness of solar charging is limited based on environmental conditions, such as weather conditions. While users of solar-powered vehicles may acquire weather forecast information to determine ideal charging locations, users cannot readily estimate an amount of time required for the vehicles to be charged to desired amounts at said locations since attributes of said locations change dynamically and users may fail to account for other environmental conditions that can adversely impact solar charging at said locations. As such, there is a need in the art that accounts for the aforementioned issues.

The listing or discussion of a prior-published document or any background in this specification should not necessarily be taken as an acknowledgement that the document or background is part of the state of the art or is common general knowledge.

### BRIEF SUMMARY

According to a first aspect, an apparatus comprising at least one processor and at least one non-transitory memory including computer program code instructions is described. The computer program code instructions, when executed, cause the apparatus to: receive historical data of events in which solar-powered vehicles equipped with solar panels were electrically charged by receiving solar beams at the solar panels, the historical data indicating factors of the events that induced objects forming on the solar panels and obstructing, at least in part, the solar beams; and using the historical data, train a machine learning model to output a charging efficiency rate of a target solar-powered vehicle as a function of at least one attribute associated with a location.

According to a second aspect, a non-transitory computer-readable storage medium having computer program code instructions stored therein is described. The computer program code instructions, when executed by at least one processor, cause the at least one processor to: receive location data indicating a location; using map data, sensor data, or a combination thereof, identify at least one attribute associated with the location; input the at least one attribute to a machine learning model, wherein the machine learning model is trained based on historical data of events in which solar-powered vehicles equipped with solar panels were electrically charged by receiving solar beams at the solar panels, the historical data indicating factors of the events that induced objects forming on the solar panels and obstructing, at least in part, the solar beams; and cause, at a user interface, a notification of an output of the machine learning model as a function of the at least one attribute, wherein the output indicates a charging efficiency rate of a target solar-powered vehicle.

According to a third aspect, a method of maintaining a map layer is described. The method includes: using map data, sensor data, or a combination thereof, identifying at least one attribute associated with a location; inputting the at least one attribute to a machine learning model, wherein the machine learning model is trained based on historical data of events in which solar-powered vehicles equipped with solar panels were electrically charged by receiving solar beams at the solar panels, the historical data indicating factors of the events that induced objects forming on the solar panels and obstructing, at least in part, the solar beams; and updating the map layer to include a datapoint indicating an output of the machine learning model as a function of the at least one attribute, wherein the output indicates a charging efficiency rate of a target solar-powered vehicle, and wherein the map layer includes one or more other data points indicating one or more other charging efficiency rates of the target solar-powered vehicle for one or more other locations.

Also, a computer program product may be provided. For example, a computer program product comprising instructions which, when the program is executed by a computer, cause the computer to carry out the steps described herein.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

### BRIEF DESCRIPTION OF THE DRAWING

The embodiments of the invention are illustrated by way of example, and not by way of limitation, in the figures of the accompanying drawings:

FIG. 1 illustrates a diagram of a system capable of providing charging efficiency rates for solar-powered vehicles;

FIG. 2 illustrates a diagram of the database within the system of FIG. 1;

FIG. 3 illustrates a diagram of the components of the assessment platform of FIG. 1;

FIG. 4 illustrates a first example visual representation output by a presentation module of FIG. 3;

FIG. 5 illustrates a second example visual representation output by the presentation module of FIG. 3;

FIG. 6 illustrates a flowchart of a process for training a machine learning model to provide charging efficiency rates for solar-powered vehicles;

FIG. 7 illustrates a flowchart of a process for using a machine learning model to provide charging efficiency rates for solar-powered vehicles;

FIG. 8 illustrates a computer system upon which an embodiment may be implemented;

FIG. 9 illustrates a chip set or chip upon which an embodiment may be implemented; and

FIG. 10 illustrates a diagram of exemplary components of a mobile terminal for communications, which is capable of operating in the system of FIG. 1.

### DETAILED DESCRIPTION

Solar-powered vehicles rely on ideal weather conditions to optimally charge power sources thereof. Certain systems may provide weather information related to amount of sunlight exposure within various locations and identify the most optimal location for charging solar-powered vehicles within a given area. While such systems provide utility by informing solar-powered vehicle users regarding such location based on weather information, the system does not account for other environmental conditions that may adversely impact solar charging of the vehicles. As such, information indicating, for example, an estimated amount of time to a desired charge amount may be inaccurate and render inconvenience for users. There will now be described an apparatus and associated methods that may address these issues.

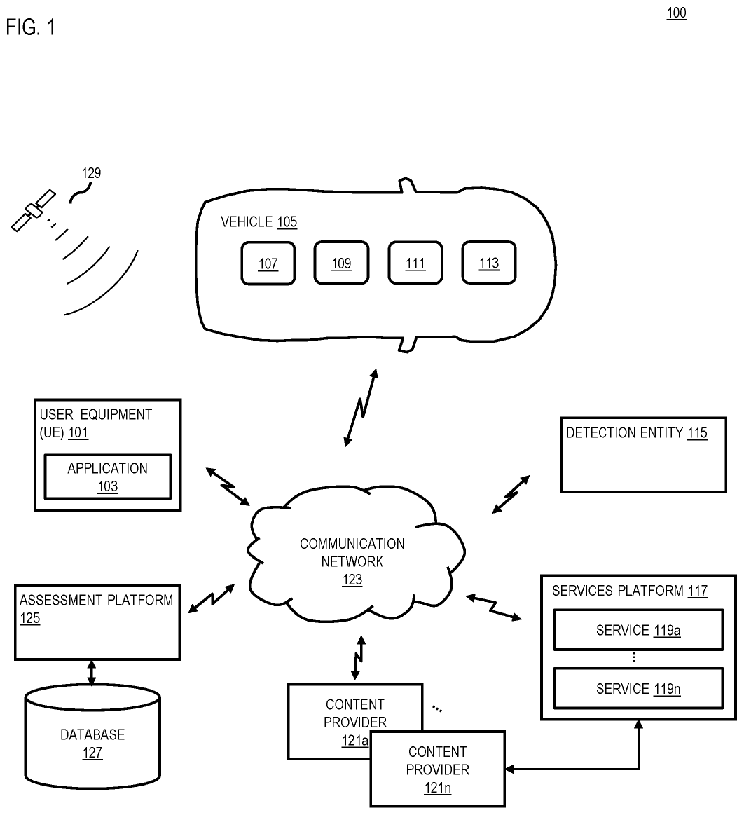

FIG. 1 is a diagram of a system 100 capable of providing charging efficiency rates for solar-powered vehicles, according to one embodiment. The system includes a user equipment (UE) 101, a solar-powered vehicle 105, a detection entity 115, a services platform 117, content providers 121a-121n, a communication network 123, an assessment platform 125, a database 127, and a satellite 129. Additional or a plurality of mentioned components may be provided.

In the illustrated embodiment, the system 100 comprises a user equipment (UE) 101 that may include or be associated with an application 103. In one embodiment, the UE 101 has connectivity to the assessment platform 125 via the communication network 123. The assessment platform 125 performs one or more functions associated with providing charging efficiency rates for solar-powered vehicles. In the illustrated embodiment, the UE 101 may be any type of mobile terminal or fixed terminal such as a mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, devices associated with or integrated with a vehicle, or any combination thereof, including the accessories and peripherals of these devices. In one embodiment, the UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the UE 101 can be a cellular telephone. A user may use the UE 101 for navigation functions, for example, road link map updates. It should be appreciated that the UE 101 can support any type of interface to the user (such as “wearable” devices, etc.).

In the illustrated embodiment, the application 103 may be any type of application that is executable by the UE 101, such as a mapping application, a location-based service application, a navigation application, a content provisioning service, a camera/imaging application, a media player application, a social networking application, a calendar application, or any combination thereof. In one embodiment, one of the applications 103 at the UE 101 may act as a client for the assessment platform 125 and perform one or more functions associated with the functions of the assessment platform 125 by interacting with the assessment platform 125 over the communication network 123. The application 103 may assist in conveying and/or receiving information regarding charging efficiency rates for a solar-powered vehicle at one or more locations. For example, the application 103 may cause the UE 101 to provide a notification indicating a charging efficiency rate for a given location of a given solar-powered vehicle type for a given duration at a given time of day, factors that impact charging efficiency rates, an estimated amount of time until a state of charge of a solar-powered vehicle reaches a desired amount, etc.

The vehicle 105 may be a hybrid vehicle, an electric vehicle, and/or any other mobility implement type of vehicle that uses, at least in part, electrical power to drive the vehicle. The vehicle 105 includes parts related to mobility, such as a powertrain with an engine, a transmission, a suspension, a driveshaft, and/or wheels, etc. The vehicle 105 may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle 105 may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle 105, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, the UE 101 may be integrated in the vehicle 105, which may include assisted driving vehicles such as autonomous vehicles, highly assisted driving (HAD), and advanced driving assistance systems (ADAS). Any of these assisted driving systems may be incorporated into the UE 101. Alternatively, an assisted driving device may be included in the vehicle 105. The assisted driving device may include memory, a processor, and systems to communicate with the UE 101. In one embodiment, the vehicle 105 may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle 105 may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

The vehicle 105 includes a solar power receiving unit 107, which is defined at least in part by one or more solar panels. The solar power receiving unit 107 may further include other electronic components/circuits for delivering power from the solar panels to a power supply of the vehicle 105. In one embodiment, the solar panels may be monocrystalline solar panels, polycrystalline solar panels, passivated emitter and rear cell (PERC) panels, thin-film solar panels (e.g., cadmium telluride (CdTe) panels, amorphous silicon (a-Si) panels, or copper indium gallium selenide (CIGS) panels), or a combination thereof. In one embodiment, the solar panels are mounted on an exterior surface of the vehicle 105 and/or integrated with the exterior surface of the vehicle 105. In one embodiment, the solar panels may be rotatably connected to the exterior surface via intermediary machineries, thereby enabling a user to manually alter orientations of the solar panels and/or the vehicle 105 to provide signals to the machineries to alter the orientations of the solar panels.

The sensors 109 may include image sensors (e.g., electronic imaging devices of both analog and digital types, which include digital cameras, camera modules, camera phones, thermal imaging devices, radar, sonar, lidar, etc.), a network detection sensor for detecting wireless signals or receivers for different short-range communications (e.g., Bluetooth, Wi-Fi, Li-Fi, near field communication (NFC), etc.), temporal information sensors, an audio recorder for gathering audio data, velocity sensors, light sensors, oriental sensors augmented with height sensor and acceleration sensor, suspension sensor, tilt sensors to detect the degree of incline or decline of the vehicle 105 along a path of travel, wind direction sensors, precipitation sensors, etc. In a further embodiment, sensors about the perimeter of the vehicle 105 may detect the relative distance of the vehicle 105 from road objects (e.g., road markings), lanes, or roadways, the presence of other vehicles, pedestrians, traffic lights, road objects, road features (e.g., curves) and any other objects, or a combination thereof. In one embodiment, the vehicle 105 may include GPS receivers to obtain geographic coordinates from satellites 127 for determining current location and time associated with the vehicle 105. Further, the location can be determined by a triangulation system such as A-GPS, Cell of Origin, or other location extrapolation technologies. In one embodiment, the sensors 109 may include particle detection sensors, such as lidar, air pollution sensors, etc., to detect a density of airborne particles local to the vehicle 105.

The on-board communications platform 111 includes wired or wireless network interfaces to enable communication with external networks. The on-board communications platform 111 also includes hardware (e.g., processors, memory, storage, antenna, etc.) and software to control the wired or wireless network interfaces. In the illustrated example, the on-board communications platform 111 includes one or more communication controllers (not illustrated) for standards-based networks (e.g., Global System for Mobile Communications (GSM), Universal Mobile Telecommunications System (UMTS), Long Term Evolution (LTE) networks, 5G networks, Code Division Multiple Access (CDMA), WiMAX (IEEE 802.16m); Near Field Communication (NFC); local area wireless network (including IEEE 802.11 a/b/g/n/ac or others), dedicated short range communication (DSRC), and Wireless Gigabit (IEEE 802.11ad), etc.). In some examples, the on-board communications platform 111 includes a wired or wireless interface (e.g., an auxiliary port, a Universal Serial Bus (USB) port, a Bluetooth® wireless node, etc.) to communicatively couple with the UE 101.

The on-board computing platform 113 performs one or more functions associated with the vehicle 105. In one embodiment, the on-board computing platform 109 may aggregate sensor data generated by at least one of the sensors 109 and transmit the sensor data via the on-board communications platform 111. The on-board computing platform 109 may receive control signals for performing one or more of the functions from the assessment platform 125, the UE 101, the services platform 117, one or more of the content providers 121a-121n, or a combination thereof via the on-board communication platform 111. The on-board computing platform 113 includes at least one processor or controller and memory (not illustrated). The processor or controller may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory. The on-board computing platform 113 may embody a software for performing one or more functions associated with determining charging efficiency rates for the vehicle 105. The software may be stored in the memory as computer program code and may be executable by the processor of the on-board computing platform 113 to cause the processor to interact with various components of the vehicle 105, establish communication with the assessment platform 125 via the on-board communications platform 111, or a combination thereof. In one embodiment, the software may be downloaded from the assessment platform 125.

The detection entity 115 may be another vehicle, a drone, a user equipment, a road-side sensor, or a device mounted on a stationary object within or proximate to a road segment (e.g., a traffic light post, a sign post, a post, a building, etc.). The detection entity 115 may include one or more image sensors, such as electronic imaging devices of both analog and digital types, which include digital cameras, camera modules, camera phones, thermal imaging devices, radar, sonar, lidar, etc. The sensors 109 may include particle detection sensors, such as lidar, air pollution sensors, etc., to detect a density of airborne particles local to the detection entity 115. The detection entity 115 may further include a network detection sensor for detecting wireless signals or receivers for different short-range communications (e.g., Bluetooth, Wi-Fi, Li-Fi, near field communication (NFC), etc.), temporal information sensors, an audio recorder for gathering audio data, velocity sensors, light sensors, oriental sensors augmented with height sensor and acceleration sensor, tilt sensors to detect the degree of incline or decline of the detection entity 115 along a path of travel, wind direction sensors, precipitation sensors, etc. In a further embodiment, sensors about the perimeter of the detection entity 115 may detect the relative distance of the detection entity 115 from road objects (e.g., road markings), lanes, or roadways, the presence of other vehicles, pedestrians, traffic lights, road objects, road features (e.g., curves) and any other objects, or a combination thereof. In one embodiment, the detection entity 115 may include GPS receivers to obtain geographic coordinates from satellites 127 for determining current location and time associated with the detection entity 115. Further, the location can be determined by a triangulation system such as A-GPS, Cell of Origin, or other location extrapolation technologies. The detection entity 115 may further include a receiver and a transmitter for maintaining communication with the assessment platform 125 and/or other components within the system 100.

The services platform 117 may provide one or more services 119a-119n (collectively referred to as services 119), such as mapping services, navigation services, travel planning services, weather-based services, emergency-based services, notification services, social networking services, content (e.g., audio, video, images, etc.) provisioning services, application services, storage services, contextual information determination services, location-based services, information-based services, etc. In one embodiment, the services platform 117 may be an original equipment manufacturer (OEM) platform. In one embodiment the one or more service 119 may be sensor data collection services. By way of example, vehicle sensor data provided by the sensors 109 may be transferred to the UE 101, the assessment platform 125, the database 127, or other entities communicatively coupled to the communication network 123 through the service platform 115. In one embodiment, the services platform 117 uses the output data generated by of the assessment platform 125 to provide services such as navigation, mapping, other location-based services, etc.

In one embodiment, the content providers 121a-121n (collectively referred to as content providers 121) may provide content or data (e.g., including geographic data, parametric representations of mapped features, etc.) to the UE 101, the vehicle 105, services platform 117, the vehicle 105, the database 127, the assessment platform 125, or the combination thereof. In one embodiment, the content provided may be any type of content, such as map content, textual content, audio content, video content, image content, etc. In one embodiment, the content providers 121 may provide content that may aid in providing charging efficiency rates for solar-powered vehicles, and/or other related characteristics. In one embodiment, the content providers 121 may also store content associated with the UE 101, the vehicle 105, services platform 117, the assessment platform 125, the database 127, or the combination thereof. In another embodiment, the content providers 121 may manage access to a central repository of data, and offer a consistent, standard interface to data, such as a repository of the database 127.

The communication network 123 of system 100 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In the illustrated embodiment, the assessment platform 125 may be a platform with multiple interconnected components. The assessment platform 125 may include multiple servers, intelligent networking devices, computing devices, components and corresponding software for providing charging efficiency rates for solar-powered vehicles. It should be appreciated that that the assessment platform 125 may be a separate entity of the system 100, included within the UE 101 (e.g., as part of the applications 103), included within the vehicle 105 (e.g., as part of an application stored in the memory of the on-board computing platform 113), included within the services platform 117 (e.g., as part of an application stored in server memory for the services platform 117), included within the content providers 121 (e.g., as part of an application stored in sever memory for the content providers 121), other platforms embodying a power supplier (not illustrated), or a combination thereof.

The assessment platform 125 is capable of acquiring sensor data, map data, and attribute data associated with solar-powered vehicles as historical data and training a machine learning model to output charging information for a target solar-powered vehicle based on one or more attributes of the target solar-powered vehicle and a given location. Herein, a target solar-powered vehicle is a vehicle-of-interest, namely, a vehicle of which a user wishes to obtain information about the vehicle. Such information may be the charging efficiency rate of the vehicle. The charging information may also indicate other information, such as an amount of charge gain/loss for a given location and a given period, an amount of time needed to charge the target solar-powered vehicle to a desired amount at said location, reasons/factors that impact solar charging of the target solar-powered vehicle, and/or other relevant information associated with solar charging of the target solar-powered vehicle at said location and period, etc.

The historical data indicates events in which solar-powered vehicles were electrically charged by receiving solar beams at the solar panels of the solar-powered vehicles. The historical data include vehicle attribute data indicating attributes of the solar-powered vehicles, location data associated the solar-powered vehicles, map data associated with the events, sensor data that are relevant to the events, other data detailing contextual information associated with the vehicles and/or the events. The vehicle attribute data may indicate, for each solar-powered vehicle as indicated in the events, a vehicle type, size, dimension, classification, a type of solar panel equipped by the vehicle, functional features of the solar panel (e.g., adjustable solar panels), a number of solar panels equipped by the vehicle, a shape/size/orientation of each solar panel equipped by the vehicle, a type of material defining exterior surfaces of the solar panel, etc. The location data may indicate, for each solar-powered vehicle as indicated in the events, one or more locations in which the vehicle was positioned while the vehicle was being charged by receiving solar beams. The map data may indicate, for each solar-powered vehicle as indicated in the events, one or more attributes associated with the one or more locations. For example, the map data may indicate a type of terrain local to a location in which a solar-powered vehicle was being charged by receiving solar beams, a type of point-of-interest (POI) and/or physical structures proximate to said location, a type of landmark proximate to said location, and/or other types of features associated with the landscape of said location. The sensor data may be acquired by the solar-powered vehicles and/or one or more detection entities 115 that was proximate to one or more of the solar-powered vehicles during the events. The sensor data may indicate charging efficiency rates including observed and calculated charging efficiency rates, an amount of power generated via solar charging, a state of charge of a solar-powered vehicle before and after a charging session, light attributes (e.g., a contrast level of light impacting an area, an intensity level of light impacting an area, temperature level of an area, a sun angle with respect to an area, etc.), wind directions, air density level, air pollution level, humidity, precipitation, etc. The observed charging efficiency rate indicates an actual charging efficiency rate recorded for a given location at a given time; whereas, the calculated charging efficiency rate is calculated as a function of light attributes of said location at said time. In one embodiment, the calculated charging efficiency rate may be further calculated based on shadow that is cast at said location at said time. In such embodiment, the area covered by the shadow may be calculated as a function a location/orientation of an object forming the shadow and a sun angle. Other data may indicate: (1) one or more activities that has occurred within or proximate to the locations of the events (e.g., construction sites, field work, farm work, etc.); (2) weather data associated with the locations of the events; (3) seasonality and impact thereof in relation to landscapes associated with the locations of the events (e.g., data indicating that terrains within or proximate to the locations of the events generate dust and/or pollens within a certain of the year); (4) other physical attributes of the locations of the events; or (5) a combination thereof. Other data may also indicate a chain of events preceding the event in which a solar-powered vehicle was charged via solar charging. The chain of events may be related to weather conditions and/or type of activities associated with a location of said event. The other data may also indicate factors that can render formation of objects (e.g., dust, pollen, etc.) on solar panels of solar-powered vehicles, thereby obstructing sunbeams projected on to the solar panels. Such factors may define types of airborne particles, conditions in which said types of airborne particles form on the solar panels, sources of airborne particles, etc. In one embodiment, the machine learning model may be incorporated with transfer learning, thereby enabling a trained version of the machine learning model to output charging information associated with a location in which no historical data were previously recorded.

Once the machine learning model is trained, the assessment platform 125 may receive a request (e.g., from the UE 101 or vehicle 105) to render charging information associated with a location for the vehicle 105. In one embodiment, once the request is received, the assessment platform 125 may acquire vehicle attribute data indicating attributes of the vehicle 105, location data associated the vehicle 105, map data associated with the location, sensor data that are relevant to the location, other data detailing contextual information associated with the vehicle 105 and/or the location. In such embodiment, said data are input to the machine learning model, and subsequently, the machine learning model outputs the charging information. Once the charging information are generated, the assessment platform 125 causes a user interface (e.g., UE 101) associated with the vehicle 105 to present the charging information.

In one embodiment, the charging information may indicate a predicted change in one or more solar charging variables over one or more periods within one or more locations. For example, the charging information may indicate a predicted change in solar charging efficiency rate of a vehicle if the vehicle is scheduled to traverse a given route at a given time. By way of another example, the charging information may also indicate an amount of charge that a vehicle will gain if the vehicle takes one route over another. In one embodiment, the charging information may be provided to a user of a solar-powered vehicle to assist the user in planning the user's trip, route, charging locations, etc. For example, the assessment platform 125 may determine that a user prefers to charge the user's vehicle at the user's workplace while the user is working and have sufficient charge by the time the user ends work to return home via the vehicle. In such example, the assessment platform 125 may determine whether the user's vehicle will have sufficient charge by the time the user ends work. If the assessment platform 125 determines that the user's vehicle will not have sufficient charge by said time, the assessment platform 125 may output charging information indicating whether the user's vehicle will have sufficient charge if the user cleans the solar panels prior to starting work. Such information provided on the charging information may provide options for the user to determine when to improve the condition of the solar-powered vehicle's charging capability, thereby enlarging the scope of the user's freedom of choice for planning activities and/or trips. In one embodiment, if the assessment platform 125 determines that a user's vehicle will not have sufficient charge to perform a subsequent action (e.g., traversing to a destination), the assessment platform 125 may generate charging information including a recommendation to extend a current charging session or move the user's vehicle to another location that does not adversely impact the charging efficiency rate of the vehicle. In one embodiment, if the assessment platform 125 predicts a change in the solar charging efficiency rate of the user's vehicle, the assessment platform 125 generates the charging information to include a reason for said change. For example, the charging information may indicate that a solar-powered vehicle will have a lower solar charging efficiency rate at a given location due to the location having a high level of likelihood of dust/dirt forming on the solar panels of the vehicle.

It is contemplated that a solar-powered vehicle is capable of being simultaneously driven and charged via solar power. As such, in one embodiment, the charging information may indicate an optimal route in which the solar-powered vehicle should traverse to gain maximum charging efficiency rates. In such embodiment, the assessment platform 125 outputs the charging information such that the route avoids areas that are likely to build up obstructing objects, such as dust, dirt, sand, pollen, ice, snow, etc., on solar panels. To determine the optimal route, the assessment platform 125 accounts for: (1) physical attributes of the solar-powered vehicle (e.g., shape, size, whether the solar panels of the vehicle is adjustable, a range of motion of the adjustable solar panels, etc.); (2) types of factors that are likely to induce airborne particles (e.g., construction sites, factories, sandy terrain, etc.) within one or more locations of the route; (3) a duration in which the solar-powered vehicle is being charged within said location; (4) one or more wind directions of said location over said duration; (5) a location, size, orientation of one or more POIs and/or physical structures proximate to said location; or (6) a combination thereof. Additionally, it is contemplated that dust, pollen, and/or other airborne particles are less likely to build up on the solar panels as the speed of the vehicle increases. As such, the charging information may also indicate an optimal speed at which the solar-powered vehicle should move to maintain optimal charging efficiency rates.

In one embodiment, if a user of a solar-powered vehicle requests to solar charge the vehicle at a single location, the charging information may also indicate an optimal orientation of the solar-powered vehicle to gain maximum charging efficiency rates. In such embodiment, to determine the orientation, the assessment platform 125 accounts for: (1) physical attributes of the solar-powered vehicle; (2) types of factors that are likely to induce airborne particles (e.g., the charging location being proximate to an active construction site) within the location in which the solar-powered vehicle is being charged; (3) a duration in which the solar-powered vehicle is being charged at said location; (4) one or more wind directions of said location over said duration; (5) a location, size, orientation of one or more POIs and/or physical structures proximate to said location; or (6) a combination thereof.

In one embodiment, the assessment platform 125 may generate the charging information by accounting for a current condition of a solar-powered vehicle and information associated with conditions of a location in which the vehicle is estimated to be positioned at a future time. By way of example, the assessment platform 125 determines that a solar-powered vehicle is following a route, and the current condition of the solar-powered vehicle is wet due to a rainstorm that has recently impacted the vehicle. In such example, the assessment platform 125 also determines that: (1) a subsequent portion of the route will be impacted by sunny and windy weather conditions; (2) said portion of the route is proximate to a flower field that is known to generate airborne pollens at the time at which the vehicle is estimated to traverse said portion; and (3) the pollens are highly likely to stick to wet surfaces of the vehicle's solar panels due to the characteristics of the pollens and the solar panels. Based on such information, the assessment platform 125 generates charging information indicating a predicted change in charging efficiency of the vehicle during a period in which the vehicle is estimated to traverse the portion.

In one embodiment, the assessment platform 125 may be communicatively coupled to one or more entities that render one or more activities associated with generating airborne particles and requests said entities to halt or delay said activities when a solar-powered vehicle is proximate to said activities. For example, the assessment platform 125 may maintain communication with a headquarter of a construction site. In such example, the assessment platform 125 obtains information that the construction site involves activities that generate substantial amount of airborne dust. As such, if the assessment platform 125 determines that a solar-powered vehicle is predicted to be within a location proximate to the construction site at a given period, the assessment platform 125 generates a message requesting the headquarter to delay the activities for said period.

In the illustrated embodiment, the database 127 stores information on road links (e.g., road length, road breadth, slope information, curvature information, geographic attributes, etc.), probe data for one or more road links (e.g., traffic density information), POIs, and other types map-related features. In one embodiment, the database 127 may include any multiple types of information that can provide means for aiding in providing charging efficiency rates for solar-powered vehicles. For example, the database 127 may store historical data indicating past events in which solar-powered vehicles were charged by receiving solar beams, attributes associated with said vehicles, conditions of environments in which said events occurred, and attributes associated with locations in which said events occurred. It should be appreciated that the information stored in the database 127 may be acquired from any of the elements within the system 100, other vehicles, sensors, database, or a combination thereof.

In one embodiment, the UE 101, the vehicle 105, the detection entity 115, the services platform 117, the content providers 121, the assessment platform 125 communicate with each other and other components of the communication network 123 using well known, new or still developing protocols. In this context, a protocol includes a set of rules defining how the network nodes within the communication network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

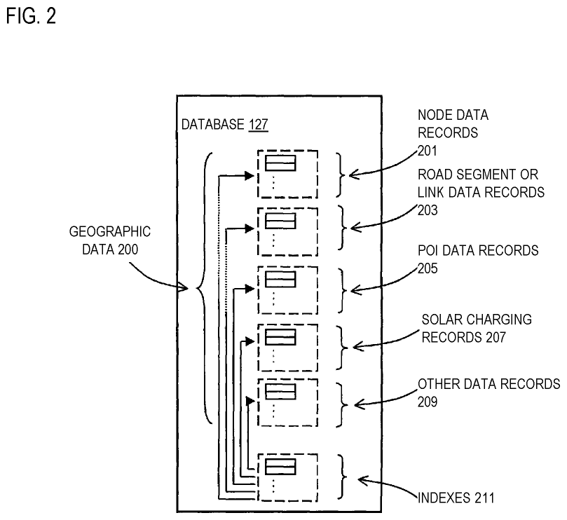

FIG. 2 is a diagram of a database 127 (e.g., a map database), according to one embodiment. In one embodiment, the database 127 includes data 200 used for (or configured to be compiled to be used for) mapping and/or navigation-related services, such as for personalized route determination, according to exemplary embodiments.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that

terms polygons and polygon extrusions/models as used herein can be used interchangeably.

In one embodiment, the following terminology applies to the representation of geographic features in the database 127.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter a shape of the link without defining new nodes).
“Oriented link”—A link that has a starting node (referred to as the “reference node”) and an ending node (referred to as the “non reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the database 127 follows certain conventions. For example, links do not cross themselves and do not cross each other except at a node or vertex. Also, there are no duplicated shape points, nodes, or links. Two links that connect each other have a common node or vertex. In the database 127, overlapping geographic features are represented by overlapping polygons. When polygons overlap, the boundary of one polygon crosses the boundary of the other polygon. In the database 127, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the database 127 is presented according to a hierarchical or multilevel tile projection. More specifically, in one embodiment, the database 127 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

As shown, the database 127 includes node data records 201, road segment or link data records 203, POI data records 205, solar charging records 207, other records 209, and indexes 211, for example. More, fewer or different data records can be provided. In one embodiment, additional data records (not shown) can include cartographic (“carto”) data records, routing data, and maneuver data. In one embodiment, the indexes 211 may improve the speed of data retrieval operations in the database 127. In one embodiment, the indexes 211 may be used to quickly locate data without having to search every row in the database 127 every time it is accessed.

In exemplary embodiments, the road segment data records 203 are links or segments representing roads, streets, or paths, as can be used in the calculated route or recorded route information for determination of one or more personalized routes. The node data records 201 are end points (such as intersections) corresponding to the respective links or segments of the road segment data records 203. The road link data records 203 and the node data records 201 represent a road network, such as used by vehicles, cars, and/or other entities. Alternatively, the database 127 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

Links, segments, and nodes can be associated with attributes, such as geographic coordinates, a number of road objects (e.g., road markings, road signs, traffic light posts, etc.), types of road object, traffic directions for one or more portions of the links, segments, and nodes, traffic history associated with the links, segments, and nodes, street names, address ranges, speed limits, turn restrictions at intersections, presence of roadworks, and other navigation related attributes, as well as POIs, such as gasoline stations, hotels, restaurants, museums, stadiums, offices, automobile dealerships, auto repair shops, factories, buildings, stores, parks, etc. The database 127 can include data about the POIs and their respective locations in the POI data records 205. The database 127 can also include data about places, such as cities, towns, or other communities, and other geographic features, such as bodies of water, mountain ranges, etc. Such place or feature data can be part of the POI data records 205 or can be associated with POIs or POI data records 205 (such as a data point used for displaying or representing a position of a city).

The solar charging records 207 include historical data indicating events in which solar-powered vehicles were electrically charged by receiving solar beams. The historical data include vehicle attribute data indicating attributes of the solar-powered vehicles, location data associated the solar-powered vehicles, map data associated with the events, sensor data that are relevant to the events, other data detailing contextual information associated with the vehicles and/or the events. The vehicle attribute data may indicate, for each solar-powered vehicle as indicated in the events, a vehicle type, size, dimension, classification, a type of solar panel equipped by the vehicle, functional features of the solar panel (e.g., adjustable solar panels), a number of solar panels equipped by the vehicle, a shape/size/orientation of each solar panel equipped by the vehicle, a type of material defining exterior surfaces of the solar panel, etc. The location data may indicate, for each solar-powered vehicle as indicated in the events, one or more locations in which the vehicle was positioned while the vehicle was being charged by receiving solar beams. The map data may indicate, for each solar-powered vehicle as indicated in the events, one or more attributes associated with the one or more locations. For example, the map data may indicate a type of terrain local to a location in which a solar-powered vehicle was being charged by receiving solar beams, a type of POI and/or physical structures proximate to said location, a type of landmark proximate to said location, and/or other types features associated with the landscape of said location, etc. The sensor data may indicate charging efficiency rates including observed and calculated charging efficiency rates, an amount of power generated via solar charging, a state of charge of a solar-powered vehicle before and after a charging session, light attributes (e.g., a contrast level of light impacting an area, an intensity level of light impacting an area, temperature level of an area, etc.), wind directions, air density level, air pollution level, humidity, precipitation, etc. Other data may indicate: (1) one or more activities that has occurred within or proximate to the locations of the events (e.g., construction sites, field work, farm work, etc.); (2) weather data associated with the locations of the events; (3) seasonality and impact thereof in relation to landscapes associated with the locations of the events (e.g., data indicating that terrains within or proximate to the locations of the events generate pollens within a certain of the year); (4) other physical attributes of the locations of the events; or (5) a combination thereof. Other data may also indicate a chain of events preceding the event in which a solar-powered vehicle was charged via solar charging. The chain of events may be related to weather conditions and/or type of activities associated with a location of said event. The other data may also indicate factors that can render formation of objects (e.g., dust, pollen, etc.) on solar panels of solar-powered vehicles, thereby obstructing sunbeams projected on to the solar panels. Such factors may define types of airborne particles, conditions in which said types of airborne particles form on the solar panels, source of airborne particles, etc.

Other records 209 may include vehicle attribute data detailing specific characteristics and/or features of solar-powered vehicles, such as types of solar panel equipped by the vehicles, an amount of power capable of being generated by the solar panel, functional features of the solar panels, a number of solar panels equipped by the vehicle, a shape/size/orientation of each solar panel equipped by the vehicle, a type of material defining exterior surfaces of the solar panel, etc. Other records 209 may also include information indicating types of airborne particle generated by types of terrain, types of construction work, types of landscape, seasonality/periods in which the types of airborne particle are generated, conditions in which the types of airborne particle are generated, degrees at which the types of airborne particle are likely to attach to types of material, conditions in which the types of airborne particles attach to the types of material, and other properties associated with the types of airborne particle.

In one embodiment, the database 127 can be maintained by the services platform 117 and/or one or more of the content providers 121 in association with a map developer. The map developer can collect geographic data to generate and enhance the database 127. There can be different ways used by the map developer to collect data. These ways can include obtaining data from other sources, such as municipalities or respective geographic authorities. In addition, the map developer can employ field personnel to travel by vehicle along roads throughout the geographic region to observe attributes associated with one or more road segments and/or record information about them, for example. Also, remote sensing, such as aerial or satellite photography, can be used.

The database 127 can be a master database stored in a format that facilitates updating, maintenance, and development. For example, the master database or data in the master database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

The processes described herein for providing charging efficiency rates for solar-powered vehicles may be advantageously implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof.

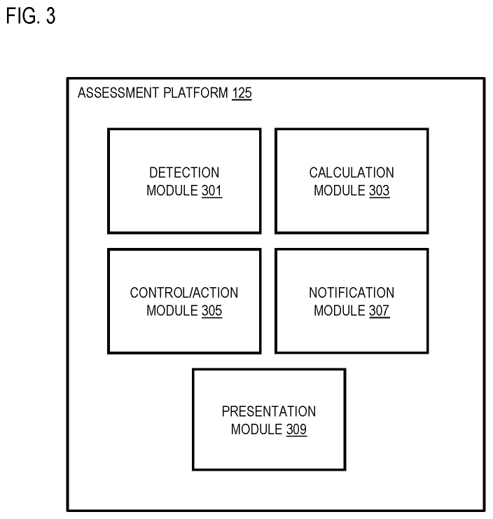

FIG. 3 is a diagram of the components of the assessment platform 125, according to one embodiment. By way of example, the assessment platform 125 includes one or more components for providing charging efficiency rates for solar-powered vehicles. It is contemplated that the functions of these components may be combined in one or more components or performed by other components of equivalent functionality. In this embodiment, the assessment platform 125 includes a detection module 301, a calculation module 303, a control/action module 305, a notification module 307, and a presentation module 309.

The detection module 301 acquires historical data for training a machine learning model to output charging information for the vehicle 105 based on one or more attributes of the vehicle 105 and a given location. The historical data indicates events in which solar-powered vehicles were electrically charged by receiving solar beams at the solar panels of the solar-powered vehicles. The detection module 301 may acquire the historical data from one or more detection entities 115 that were positioned in the locations of the events. The services platform 117 and/or the content provider 121 may also store information relevant to the events (e.g., weather forecast information, light attribute data, etc.). As such, the detection module 301 may further acquire such information from the services platform 117 and/or the content provider 121.

In one embodiment, the detection module 301 may receive a request from the UE 101 or the vehicle 105 to provide charging information for the vehicle 105 at one or more locations. In response, the detection module 301 may acquire: (1) vehicle attribute data indicating attributes of the vehicle 105; (2) location data associated said locations (e.g., a route of the vehicle 105); (3) sensor data associated with said locations (e.g., sensor data acquired by one or more detection entities 115 within said locations); (4) information indicating one or more activities that is currently occurring or is scheduled to occur at or proximate to said locations (e.g., construction work, field work, etc.); (5) weather data associated with said location (e.g., weather forecast information); (6) information indicating seasonality and impact thereof in relation to landscapes associated with said location; (7) travel data associated with a user of the vehicle 105 (e.g., one or more destinations, routes, mobility pattern, etc.); or (8) a combination thereof. The detection module 301 may acquire such data from the vehicle 105, one or more detection entities 115, the services platform 117, the content provider 121, the database 127, or a combination thereof.

The calculation module 303 embodies the machine learning model and trains the machine learning model based on the historical data acquired by the detection module 301. Once the machine learning model is trained, the calculation module 303 uses the trained machine learning model to output the charging information for the vehicle 105 based on data acquired by the detection module 301. The charging information may indicate a predicted change in one or more solar charging variables over one or more periods within one or more locations. For example, the charging information may indicate a predicted change in solar charging efficiency rate of the vehicle 105 if the vehicle 105 is to traverse a given route at a given time. By way of another example, the charging information may also indicate an amount of charge that the vehicle 105 will gain if the vehicle 105 takes one route over another. In one embodiment, the charging information may be provided to a user of the vehicle 105 (e.g., via the UE 101 and/or the vehicle 105) to assist the user in planning the user's trip, route, charging locations, etc. In one embodiment, if the calculation module 303 determines that a user's vehicle will not have sufficient charge to perform a subsequent action (e.g., traversing to a destination), the calculation module 303 may generate charging information including a recommendation to extend a current charging session or move the vehicle 105 to another location that does not adversely impact the charging efficiency rate of the vehicle 105.

In one embodiment, the charging information may indicate an optimal route in which the solar-powered vehicle should traverse to gain maximum charging efficiency rates. In such embodiment, the calculation module 303 outputs the charging information such that the route avoids areas that are likely to build up obstructing objects, such as dust, sand, pollen, ice, snow, etc., on the solar panels. To determine the optimal route, the calculation module 303 accounts for: (1) physical attributes of the solar-powered vehicle (e.g., shape, size, whether the solar panels of the vehicle is adjustable, a range of motion of the adjustable solar panels, etc.); (2) types of factors that are likely to induce airborne particles (e.g., active construction sites, factories, sandy terrain, etc.) within one or more locations of the route; (3) a duration in which the solar-powered vehicle is being charged within said location; (4) one or more wind directions of said location over said duration; (5) a location, size, and/or orientation of one or more POIs and/or physical structures proximate to said location; or (6) a combination thereof. Additionally, it is contemplated that dust, pollen, and/or other airborne particles are less likely to build up on the solar panels as the speed of the vehicle increases. As such, the charging information may also indicate an optimal speed at which the solar-powered vehicle should move to maintain optimal charging efficiency rates.

In one embodiment, if a user of a solar-powered vehicle requests to solar charge the vehicle at a single location, the charging information may also indicate an optimal orientation of the solar-powered vehicle to gain maximum solar charging rates. In such embodiment, to determine the orientation, the calculation module 303 accounts for: (1) physical attributes of the solar-powered vehicle; (2) types of factors that are likely to induce airborne particles (e.g., construction sites) within the location in which the solar-powered vehicle is being charged; (3) a duration in which the solar-powered vehicle is being charged at said location; (4) one or more wind directions of said location over said duration; (5) a location, size, orientation of one or more POIs and/or physical structures proximate to said location; or (6) a combination thereof.

In one embodiment, the calculation module 303 may generate the charging information by accounting for a current condition of a solar-powered vehicle and information associated with conditions of a location in which the vehicle is estimated to be positioned at a future time. By way of example, the calculation module 303 determines that a solar-powered vehicle is following a route, and the current condition of the solar-powered vehicle is wet due to a rainstorm that has recently impacted the vehicle. In such example, the calculation module 303 also determines that: (1) a subsequent portion of the route will be impacted by sunny and windy weather conditions; (2) said portion of the route is proximate to a flower field that is known to generate airborne pollens at the time at which the vehicle is estimated to traverse said portion; and (3) the pollens are highly likely to stick to wet surfaces of the vehicle's solar panels due to the characteristics of the pollens and the solar panels. Based on such information, the calculation module 303 generates charging information indicating a predicted change of charging efficiency for the vehicle during a period in which the vehicle is estimated to traverse the portion.

In one embodiment, the calculation module 303 predicts one or more variables that attribute to a significant change in charging efficiency rate. For example, the machine learning model may learn that a charging efficiency rate for the vehicle 105 drops a significant amount when the vehicle 105 traverses a road link proximate to a type of flower field at a certain period of a year. In such example, the machine learning model may further learn that the reason for the drop is due to a type of airborne pollens generated by said flower field at said period of the year. Specifically, the machine learning model may learn that said airborne pollens easily attach to exterior surfaces of solar panels of the vehicle 105, thereby obstructing sun beams projected on to the solar panels. To determine whether objects, such as dust, pollens, etc., are formed on solar panels of the vehicle 105, the calculation module 303 may determine a calculated charging efficiency rate for a given location and compare the calculated charging efficiency rate to an observed charging efficiency rate acquired at the location. If there is a difference between the calculated charging efficiency rate and the observed charging efficiency rate, the calculation module 303 concludes that the solar panels are obstructed, at least partially, from receiving sunbeams.

In one embodiment, the control/action module 305 generates vehicle maneuver commands based on routing information output by the calculation module 303. For example, the calculation module 303 may predict a route to a destination that provides an optimal charging efficiency rate for the vehicle 105. In such embodiment, the control/action module 305 outputs the vehicle maneuver commands to the vehicle 105 and causes the vehicle 105 to autonomously traverse to the destination based on the vehicle maneuver commands.

The notification module 307 may cause a notification on the UE 101 and/or other user interfaces available within the vehicle. The notification may indicate the charging information output by the calculation module 303. The notification may include sound notification, display notification, vibration, or a combination thereof.

The presentation module 309 obtains a set of information, data, and/or calculated results from other modules, and continues with providing a visual representation to the UE 101 and/or any other user interface associated with the vehicle 105. The visual representation may indicate any of the information presented by the notification module 307.

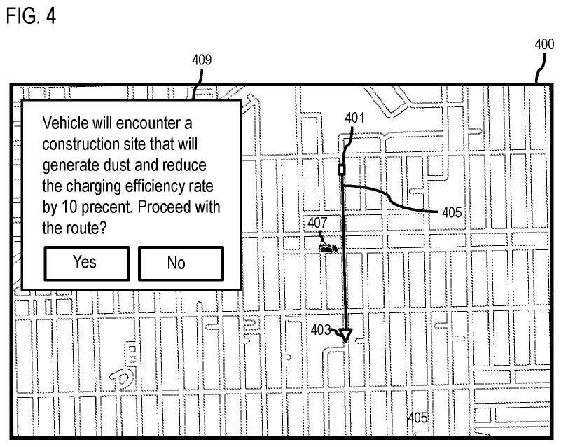

FIG. 4 illustrates a first example visual representation 400 output by the presentation module 309. The first example visual representation 400 illustrates a scenario in which a solar-powered vehicle 401 is attempting to reach a destination 403 by traversing a route 405. The detection module 301 has determined that a construction work 407 is in progress proximate to the route 405 and is currently generating airborne dust. The calculation module 303 has used the machine learning model to estimate an impact of the airborne dust to the charging efficiency rate of the vehicle 401 and has predicted that the charging efficiency rate will be reduced if the vehicle 401 traverses the route 405. As such, a message prompt 407 states “VEHICLE WILL ENCOUNTER A CONSTRUCTION SITE THAT WILL GENERATE DUST AND REDUCE THE CHARGING EFFICIENCY RATE BY 10 PRECENT. PROCEED WITH THE ROUTE?”

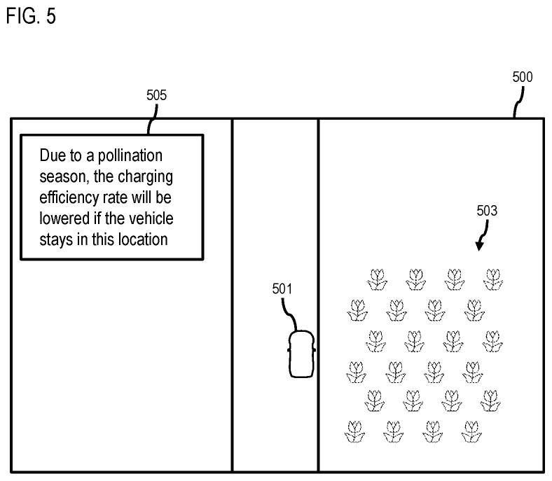

FIG. 5 illustrates a second example visual representation 500 output by the presentation module 309. The second example visual representation 500 illustrates a scenario in which a solar-powered vehicle is parked next to a flower field. The detection module 301 has determined that a vehicle 501 has parked next to a flower field 503. The calculation module 303 has predicted that if the vehicle 501 continues to park within the current location thereof, airborne pollens generated by the flower field 503 will attach to the solar panels of the vehicle 501 and impact the charging efficiency rate of the vehicle 501. As such, a notification 505 states “DUE TO A POLLINATION SEASON, THE CHARGING EFFICIENCY RATE WILL BE LOWERED IF THE VEHICLE STAYS IN THIS LOCATION.”

The above presented modules and components of the assessment platform 125 can be implemented in hardware, firmware, software, or a combination thereof. Though depicted as a separate entity in FIG. 3, it is contemplated that the assessment platform 125 may be implemented for direct operation by the UE 101, the vehicle 105, the services platform 117, one or more of the content providers 121, or a combination thereof. As such, the assessment platform 125 may generate direct signal inputs by way of the operating system of the UE 101, the vehicle 105, the detection entity 15, the services platform 117, the one or more of the content providers 121, or the combination thereof for interacting with the applications 103. The various executions presented herein contemplate any and all arrangements and models.

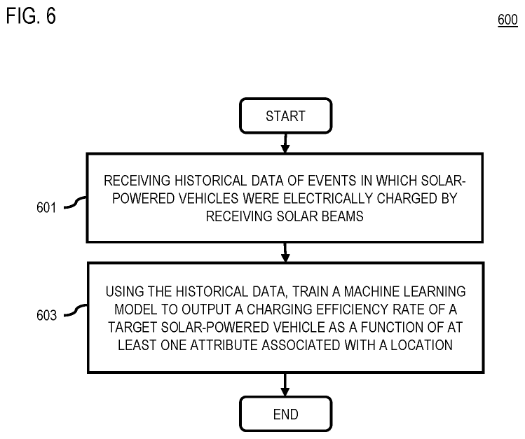

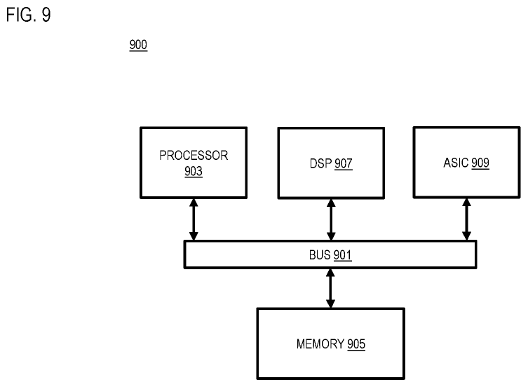

FIG. 6 is a flowchart of a process 600 for training a machine learning model to provide charging efficiency rates for solar-powered vehicles. In one embodiment, the assessment platform 125 performs the process 600 and is implemented in, for instance, a chip set including a processor and a memory as shown in FIG. 9.

In step 601, the assessment platform 125 receives historical data of events in which solar-powered vehicles were electrically charged by receiving solar beams. The historical data include vehicle attribute data indicating attributes of the solar-powered vehicles, location data associated the solar-powered vehicles, map data associated with the events, sensor data that are relevant to the events, other data detailing contextual information associated with the vehicles and/or the events. The vehicle attribute data may indicate, for each solar-powered vehicle as indicated in the events, a vehicle type, size, dimension, classification, a type of solar panel equipped by the vehicle, functional features of the solar panel (e.g., adjustable solar panels), a number of solar panels equipped by the vehicle, a shape/size/orientation of each solar panel equipped by the vehicle, a type of material defining exterior surfaces of the solar panel, etc. The location data may indicate, for each solar-powered vehicle as indicated in the events, one or more locations in which the vehicle was positioned while the vehicle was being charged by receiving solar beams. The map data may indicate, for each solar-powered vehicle as indicated in the events, one or more attributes associated with the one or more locations. The sensor data may be acquired by the solar-powered vehicles and/or one or more sensors/probes that was proximate to one or more of the solar-powered vehicles during the events. The sensor data may indicate charging efficiency rates including observed and calculated charging efficiency rates, an amount of power generated via solar charging, a state of charge of a solar-powered vehicle before and after a charging session, light attributes (e.g., a contrast level of light impacting an area, an intensity level of light impacting an area, temperature level of an area, a sun angle with respect to an area, etc.), wind directions, air density level, air pollution level, humidity, precipitation, etc. Other data may indicate: (1) one or more activities that has occurred within or proximate to the locations of the events (e.g., construction sites, field work, farm work, etc.); (2) weather data associated with the locations of the events; (3) seasonality and impact thereof in relation to landscapes associated with the locations of the events (e.g., data indicating that terrains within or proximate to the locations of the events generate pollens within a certain of the year); (4) other physical attributes of the locations of the events; or (5) a combination thereof. Other data may also indicate a chain of events preceding the event in which a solar-powered vehicle was charged via solar charging. The chain of events may be related to weather conditions and/or type of activities associated with a location of said event. Other data may also indicate factors that can render formation of objects (e.g., dust, pollen, etc.) on solar panels of solar-powered vehicles, thereby obstructing sunbeams projected on to the solar panels. Such factors may define types of airborne particles, conditions in which said types of airborne particles form on the solar panels, source of airborne particles, etc.

In step 603, the assessment platform 125 uses the historical data to train a machine learning model to output a charging efficiency rate of a target solar-powered vehicle (i.e., vehicle 105) as a function of at least one attribute associated with a location. The assessment platform 126 compares the at least one attribute associated with a location to at least one relevant aspect of the historical data to predict the charging efficiency rate of the target solar-powered vehicle.

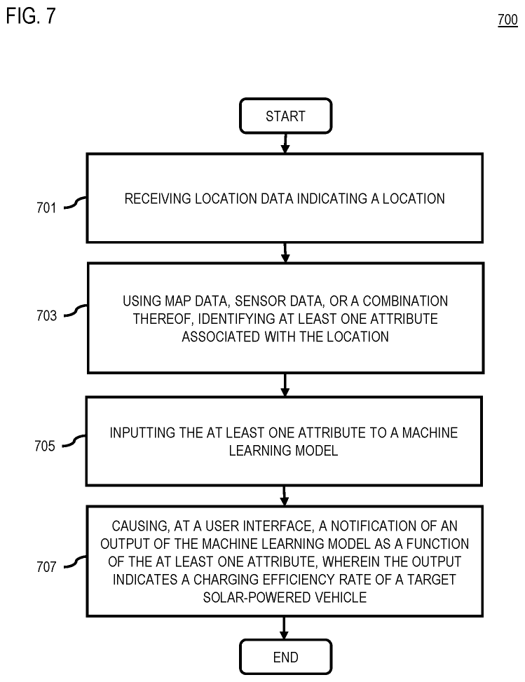

FIG. 7 is a flowchart of a process 700 for using a machine learning model to provide charging efficiency rates for solar-powered vehicles. In one embodiment, the assessment platform 125 performs the process 700 and is implemented in, for instance, a chip set including a processor and a memory as shown in FIG. 9.

In step 701, the assessment platform 125 receives location data indicating a location. The location data may be acquired via the UE 101 and/or the vehicle 105. In one embodiment, the location may be a destination of which a user wishes to arrive via the vehicle 105. In one embodiment, the location may be a portion of a route associated with the vehicle 105.

In step 703, the assessment platform 125 identifies at least one attribute associated with the location by using map data, sensor data, or a combination thereof. The sensor data may be acquired by one or more detection entities 115 that are positioned within the location (e.g., light attribute data, image data, air pollution data, etc.). The map data may indicate attributes of one or more features associated with the location (e.g., proximity to a farm, flower field, factory, etc.).

In step 705, the assessment platform 125 inputs the at least one attribute to a machine learning model. As discussed above, the machine learning model is trained based on historical data of events in which solar-powered vehicles were electrically charged by receiving solar beams. The assessment platform 126 compares the at least one attribute associated with a location to at least one relevant aspect of the historical data to predict the charging efficiency rate of the vehicle 105.

In step 707, the assessment platform 125 causes a notification at a user interface, where the notification indicates an output of the machine learning model as a function of the at least one attribute. The output indicates a charging efficiency rate of a target solar-powered vehicle (i.e., the vehicle 105). The user interface may be defined by the UE 101 or equipped within the vehicle 105.

The system, apparatus, and methods described herein enable a system to reliably predict events in which one or more objects, such as dirt, pollen, etc., will form on exterior surfaces of solar panels of solar-powered vehicles, thereby obstructing, at least partially, sunbeams received at the solar panels and lowering charging efficiency rates for the vehicles. As such, the system may provide routes that avoid the locations of such events thereby enabling the vehicles to maintain optimal charging efficiency rates.

The processes described herein may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

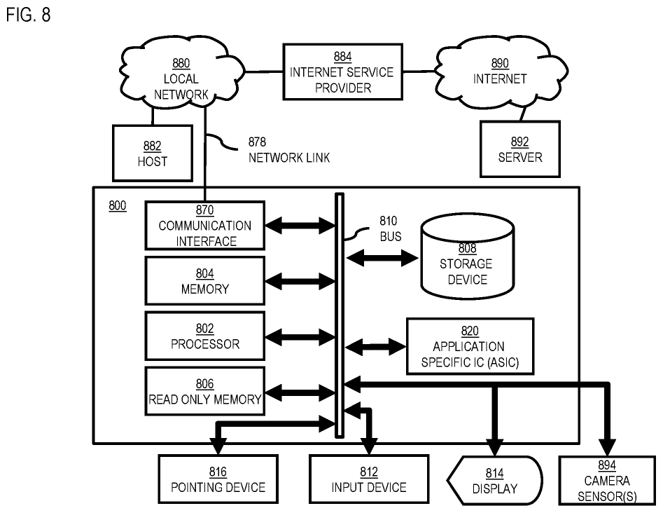

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide charging efficiency rates for solar-powered vehicles as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing charging efficiency rates for solar-powered vehicles.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing charging efficiency rates for solar-powered vehicles. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 800 also includes a memory 804 coupled to bus 810. The memory 804, such as a random access memory (RAM) or any other dynamic storage device, stores information including processor instructions for providing charging efficiency rates for solar-powered vehicles. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing charging efficiency rates for solar-powered vehicles, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 may be omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 123 for providing charging efficiency rates for solar-powered vehicles to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 882 connected to the Internet hosts a process that provides a service in response to information received over the Internet. For example, server host 882 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 882 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide charging efficiency rates for solar-powered vehicles as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing charging efficiency rates for solar-powered vehicles.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real-time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors. The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide charging efficiency rates for solar-powered vehicles. The memory 905 also stores the data associated with or generated by the execution of the inventive steps.

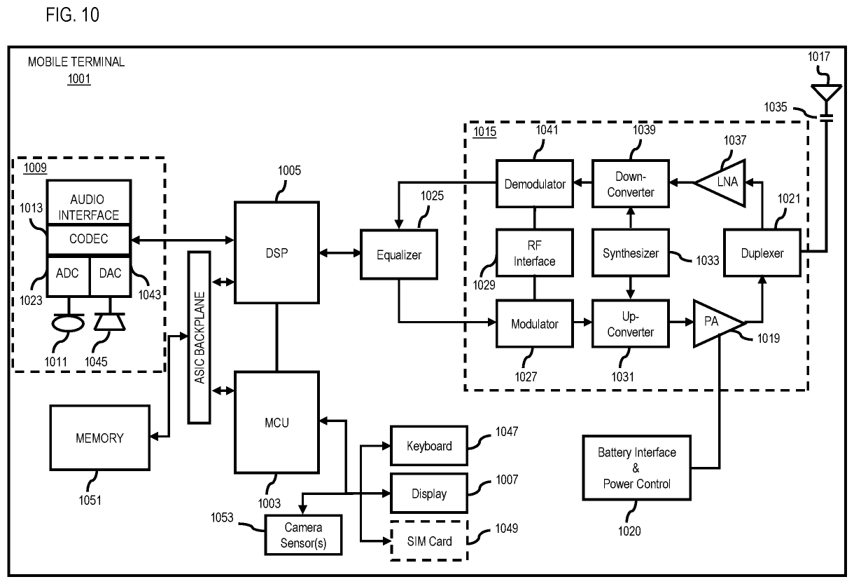

FIG. 10 is a diagram of exemplary components of a mobile terminal 1001 (e.g., a mobile device or vehicle or part thereof) for communications, which is capable of operating in the system of FIG. 1, according to one embodiment. In some embodiments, mobile terminal 1001, or a portion thereof, constitutes a means for performing one or more steps of providing charging efficiency rates for solar-powered vehicles. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing charging efficiency rates for solar-powered vehicles. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide charging efficiency rates for solar-powered vehicles. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1010 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1149 also contains a memory for storing a personal telephone number registry, text messages, and user specific mobile terminal settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

We (I) claim:

1. An apparatus comprising at least one processor and at least one non-transitory memory including computer program code instructions, the computer program code instructions configured to, when executed, cause the apparatus to:
receive historical data of events in which solar-powered vehicles equipped with solar panels were electrically charged by receiving solar beams at the solar panels, the historical data indicating factors of the events that induced objects forming on the solar panels and obstructing, at least in part, the solar beams; and
using the historical data, train a machine learning model to output a charging efficiency rate of a target solar-powered vehicle as a function of at least one attribute associated with a location.

2. The apparatus of claim 1, wherein the events did not occur at the location.

3. The apparatus of claim 2, wherein, the at least one attribute is a first attribute, and wherein the first attribute is the same as or similar to a second attribute of at least one of the events.

4. The apparatus of claim 1, wherein at least one of the factors is defined by proximity of one or more terrains with respect to the solar panels, and wherein the one or more terrains generates airborne particles that obstruct the solar beams.

5. The apparatus of claim 1, wherein at least one of the factors is defined by proximity of one or more construction sites with respect to the solar panels.

6. The apparatus of claim 1, wherein at least one of the factors is defined by pollution data.

7. The apparatus of claim 1, wherein at least one of the factors is defined by one or more weather conditions.

8. The apparatus of claim 1, wherein at least one of the factors is defined by an occurrence of a first type of event followed by a second type of event, wherein the first type of event renders precipitation on the solar panels and the second type of event renders airborne particles that interact with the precipitation.

9. The apparatus of claim 1, wherein the historical data further indicates vehicle attributes associated with the solar-powered vehicles, and wherein the output is also the function of at least one vehicle attribute associated with the target solar-powered vehicle.

10. A non-transitory computer-readable storage medium having computer program code instructions stored therein, the computer program code instructions, when executed by at least one processor, cause the at least one processor to:
receive location data indicating a location;
using map data, sensor data, or a combination thereof, identify at least one attribute associated with the location;
input the at least one attribute to a machine learning model, wherein the machine learning model is trained based on historical data of events in which solar-powered vehicles equipped with solar panels were electrically charged by receiving solar beams at the solar panels, the historical data indicating factors of the events that induced objects forming on the solar panels and obstructing, at least in part, the solar beams; and
cause, at a user interface, a notification of an output of the machine learning model as a function of the at least one attribute, wherein the output indicates a charging efficiency rate of a target solar-powered vehicle.

11. The non-transitory computer-readable storage medium of claim 10, wherein the computer program code instructions, when executed by the at least one processor, cause the at least one processor to:
receive solar attribute data associated with the location;
based the solar attribute data, calculate an expected charging efficiency rate of the target solar-powered vehicle at the location;
cause, at the user interface, an additional notification indicating the expected charging efficiency rate.

12. The non-transitory computer-readable storage medium of claim 10, wherein the output further indicates at least one or more of the factors that attributes to the charging efficiency rate for the location.

13. The non-transitory computer-readable storage medium of claim 10, wherein the computer program code instructions, when executed by the at least one processor, cause the at least one processor to, prior to a charging period:
receive a request for: (i) charging the target solar-powered vehicle at the location for the charging period; and (ii) a guaranteed amount of state of charge for the target solar-powered vehicle at the end of the charging period;
based on the charging efficiency rate, calculate a state of charge of the target solar-powered vehicle at the end of the charging period; and
responsive to the calculated state of charge being less than the guaranteed amount, cause, at the user interface, an additional notification indicating the calculated state of charge being less than the guaranteed amount.

14. The non-transitory computer-readable storage medium of claim 13, wherein the computer program code instructions, when executed by the at least one processor, cause the at least one processor to, responsive to the calculated state of charge being less than the guaranteed amount, based on the charging efficiency rate, calculate an amount of time needed for the state of charge to reach the guaranteed amount at the location subsequent to the charging period, wherein the additional notification further indicates the calculated amount of time.

15. The non-transitory computer-readable storage medium of claim 10, wherein the at least one attribute indicates: (i) a type of terrain within or proximate to the location; (ii) a point-of-interest (POI) within or proximate to the location; (iii) a construction site within or proximate to the location; (iv) weather information associated with location; (v) one or more past charging efficiency rates associated with the location; (vi) pollution data associated with the location; or (vii) a combination thereof.

16. A method of maintaining a map layer, the method comprising:
using map data, sensor data, or a combination thereof, identifying at least one attribute associated with a location;
inputting the at least one attribute to a machine learning model, wherein the machine learning model is trained based on historical data of events in which solar-powered vehicles equipped with solar panels were electrically charged by receiving solar beams at the solar panels, the historical data indicating factors of the events that induced objects forming on the solar panels and obstructing, at least in part, the solar beams; and
updating the map layer to include a datapoint indicating an output of the machine learning model as a function of the at least one attribute, wherein the output indicates a charging efficiency rate of a target solar-powered vehicle, and wherein the map layer includes one or more other data points indicating one or more other charging efficiency rates of the target solar-powered vehicle for one or more other locations.

17. The method of claim 16, wherein the historical data further indicates vehicle attributes associated with the solar-powered vehicles, and wherein the method further comprises inputting at least one vehicle attributes associated with the target solar-powered vehicle to the machine learning model, wherein the output is also the function of the at least one vehicle attributes.

18. The method of claim 16, wherein the sensor data are acquired from at least one sensor equipped by: (i) the target solar-powered vehicle; (ii) another vehicle within the location; (iii) a probe within the location; (iv) a stationary construct within the location; or (v) a combination thereof.

19. The method of claim 16 further comprising:
receiving solar attribute data associated with the location; and
based the solar attribute data, calculating an expected charging efficiency rate of the target solar-powered vehicle at the location, wherein the data point further indicates the expected charging efficiency rate.

20. The method of claim 16, wherein the at least one attribute indicates: (i) a type of terrain within or proximate to the location; (ii) a point-of-interest (POI) within or proximate to the location; (iii) a construction site within or proximate to the location; (iv) weather information associated with location; (v) one or more past charging efficiency rates associated with the location; (vi) pollution data associated with the location; or (vii) a combination thereof.
